(19) United States
(12) Patent Application Publication
(10) Pub. No.: US 2017/0265662 A1
(43) Pub. Date: Sep. 21, 2017

(54) FRAGRANCE ENHANCEMENT DEVICE FOR FLOWERS

(71) Applicant: Esther Lee, Las Vegas, NV (US)

(72) Inventor: Esther Lee, Las Vegas, NV (US)

(21) Appl. No.: 15/072,758

(22) Filed: Mar. 17, 2016

(51) Int. Cl. A47G 7/06; A01G 9/10; A01G 9/12; A01G 5/00

(52) U.S. Cl. CPC A47G 7/06; A01G 5/00; A01G 9/1086; A01G 9/128

(57) ABSTRACT

A device and method for retaining freshness of a cut flower by retaining the fragrance of flower head and providing stability to flower stem. The device comprises a plastic molded container for placing within a flower head of the cut flower, the container having a centrally located well filled with a gelatinous material impregnated with a fragrant liquid for emitting fragrance for an extended period. A bendable metal wire extending from a base of the plastic molded container, configured to be spirally wound around the flower stem for providing stability to the flower head attached to the stem.

### FIELD OF THE INVENTION

The present invention generally relates to devices and methods for enhancing freshness and longevity of cut flowers, and in particular, the invention relates to a device attachable to a flower stem for enhancing fragrance of cut flower and for providing support to the flower stem.

### DESCRIPTION OF RELATED ART

Cut flowers contribute to a large percentage of the sales in the floriculture industry. There is always a huge demand for beautiful, fragrant and fresh flowers, especially roses. Among cut flowers, roses are the most admired and frequently ordered flower due to its scent and romantic allure. Mainly, the sales of cut flowers are through retail florist establishments, where these cut flowers are generally kept under ideal conditions comprising cool temperature, clean air and ample moisture level.

One of the major problems associated with cut flowers is that the flower heads attached to the stem end begins to wilt and droop within few days after purchasing from a florist. The stem bends at a point where the flower bud is attached to the stem, thus causing the flower head to droop. Because of such drooping, passage of water and nutrients through the stem are blocked leading to discoloration of flower petals, and the flower eventually loses its freshness.

Another issue associated with cut flowers is decreased or lack of fragrance that is emitted from the cut flowers. Freshly cut flowers are known to emit optimal level of fragrance; however, this fragrance level gradually fades after a few days. This may lead to customer dissatisfaction especially when an expensive bouquet of flowers start wilting and expiring within a couple or a few days after purchase. Though different variety of techniques have been practiced for preserving flowers and for reviving wilted flowers, these techniques are short of providing optimal results in enhancing the fragrance of cut flowers and retaining the stability of flower stem holding the cut flower.

One such technique involves properly trimming the stem and keeping the stem in water or in a preservative solution in a cool location. Another technique involves the use of a small gauge wire, which is forced down through the head of the flower into the top section of the stem in order to raise the flower head.

Therefore, there is a need in the art for improved devices and/or methods for enhancing the fragrance and flower stem stability in cut flowers, which would retain their fresh appearance and increase the shelf life of cut flowers.

### SUMMARY OF THE INVENTION

The present invention relates to a device attachable to a flower stem for retaining freshness of a cut flower. The device is configured to enhance the fragrance of the cut flower and to provide stability to the stem part attached to the cut flower. The device comprises a plastic container filled with a gelatinous material in the form of beads. The gelatinous material can be soaked in a liquid containing the aroma or fragrance as emitted by the flower. Alternatively, the gelatinous material is capable of absorbing fragrance from the cut flower and emitting the fragrance for a prolonged period. The plastic container may comprise a hemispherical molded container consisting a well located at center for holding the gelatinous material. The device further comprises bendable metal wire extending from a base of the plastic container, wherein the wire is configured to maintain the integrity of flower bud attached to the stem, thus preventing the flower head from drooping. The bendable metal wire provides stability to the flower stem and avoids withering of the flower stem at the base of the flower bud, thereby increasing the longevity of the cut flower.

In an embodiment, the plastic container is concealed within the calyx of the cut flower. In another embodiment, addition of few drops of water into the well of the plastic container induces the emission of fragrance that is infused in the gelatinous material. In a different embodiment, water can be replaced with a fragrant liquid or a mixture of fragrant liquids.

In an embodiment, the fragrant liquid added to the gelatinous material, is non-toxic, colorless and non-staining. The fragrance emanating from the plastic container resembles natural fragrance of the cut flower, which in turn contributes to the shelf life of the cut flower. The device as disclosed in the present invention can be used for retaining freshness in both natural and artificial flowers and bouquets.

### BRIEF DESCRIPTION OF DIFFERENT VIEWS OF DRAWINGS

FIG. 1 is a top perspective view of the plastic molded container.

FIG. 2 is a top perspective view of the plastic molded container filled with gelatinous beads.

FIG. 3 is a perspective view of the device comprising the plastic molded container attached with a bendable metal wire.

### DETAILED DESCRIPTION OF DIFFERENT EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

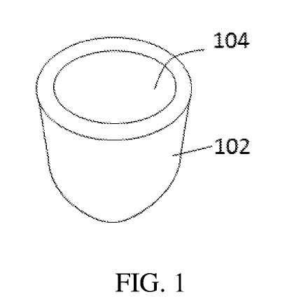

Referring to FIG. 1 showing a plastic molded container 102 comprising a well 104 located at the center configured to receive a gelatinous material impregnated with a fragrant or aromatic liquid. The plastic molded container 102 is substantially hemispherical or cylindrical in shape, according to an embodiment. The gelatinous material may be configured to absorb natural fragrance from the cut flower and emit the fragrance for an extended period, thereby retaining the freshness of the cut flower.

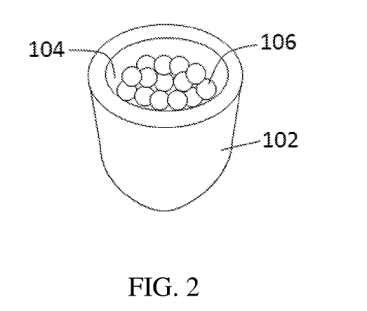

FIG. 2 shows the plastic molded container 102 with the well 104 filled with gelatinous beads 106, which can be impregnated with an artificial fragrant liquid or scent or an aromatic substance capable of emitting natural flower like fragrance. The plastic molded container 102 comprising the well 104 located at the center may also be added with few drops of water or a liquid that can induce emission of fragrance from the gelatinous beads 106 impregnated or soaked with the fragrant liquid. The plastic molded container 102 is configured to be placed within the flower head of the cut flower for enhancing the fragrance of the cut flower.

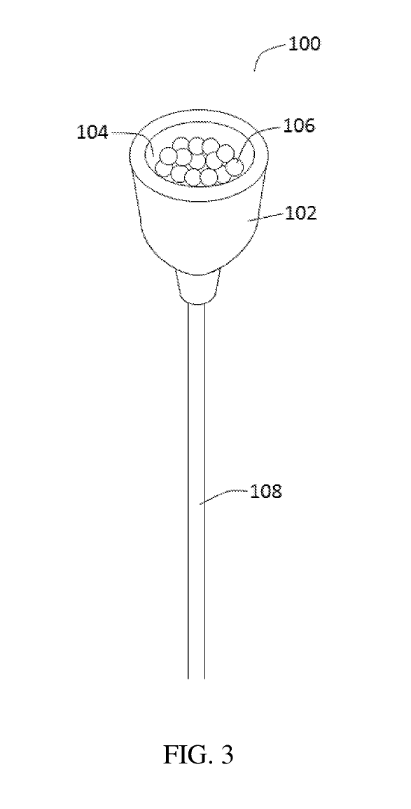

FIG. 3 shows the device 100 comprising the plastic molded container 102 attached with a bendable metal wire 108 extending from a base of the container 102, configured to be spirally wound around a stem supporting the flower head, thus preventing the flower head from drooping. The plastic molded container 102 can be placed within a flower head and the bendable metal wire 108 can be tied around along a particular length of the stem in order to support the flower head and to prevent drooping of the flower head from the stem end. The bendable metal wire 108 provides stability to the flower stem and avoids withering of the flower stem at the base of the flower bud, thereby increasing the longevity of the cut flower. In an embodiment, the bendable metal wire 108 is enclosed within a green cover for aesthetic appeal.

According to an embodiment of the present invention, the plastic molded container 102 may further comprise an absorbable material, which can be infused with the artificial fragrant substance. The gelatinous material 106 pre-soaked with fragrant liquid is present within the well 104 and the gelatinous material 106 begins to emit fragrance similar to the natural cut flower. In an embodiment, the bendable metal wire 108 may comprise natural fiber or a synthetic material, which is flexible enough for winding around the stem portion of the cut flower. By retaining the fragrance and preventing the flower head from wilting and drooping, the freshness of cut flowers can be maintained for a longer period.

In an embodiment, the plastic molded container 102 is configured to be concealed within the calyx of the cut flower. The fragrant liquid or fragrant substance is non-toxic, colorless and non-staining. The fragrance emanating from the gelatinous beads 106 resembles natural fragrance of the cut flower, which in turn contribute to increased shelf life of the cut flower. The device 100 for retaining freshness as disclosed in the present invention can be used in both natural and artificial flowers and bouquets.

The device 100 comprising the plastic molded container 102 filled with gelatinous beads infused with fragrance in accordance with the present invention may also be incorporated into an artificial or fake flower. The device 100 can also be used to enhance the fragrance or scent from natural flowers. The device 100 may be secured to the flower directly. It will be understood that it will be possible to use different materials for constructing the plastic molded container 102 or different types of solutions to use the differential diffusion capacity of those materials or solutions for enhancing the release of fragrance from the gelatinous material 106 present within the container 102. The cut flower may comprise rose flower and other flowers commonly used in flower bouquets.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. A device for retaining freshness of a cut flower, the device comprising:
A plastic molded container configured to be placed within a flower head of the cut flower;
a well located within the plastic molded container, wherein the well is filled with a gelatinous material impregnated with a fragrant liquid for emitting fragrance; and
a bendable metal wire extending from a base of the plastic molded container, configured to be wound around a stem of the cut flower for providing stability to the flower head attached to the stem.

2. The device of claim 1, wherein the plastic molded container is hemispherical in shape.

3. The device of claim 1, wherein the gelatinous material is configured to absorb natural fragrance from the cut flower and emit the fragrance.

4. The device of claim 1, wherein the fragrant liquid may comprises a natural fragrance or an artificial fragrance.

5. The device of claim 1, wherein the plastic container further comprises an absorbable material.

6. The device of claim 1, wherein the cut flower comprises a natural flower or an artificial flower.
